(19) United States
(12) Patent Application Publication
(10) Pub. No.: US 2009/0314376 A1
(43) Pub. Date: Dec. 24, 2009

(54) MODULAR CONDUIT STRUCTURE AND METHOD OF MAKING SAME

(76) Inventor: Mark S. Wagner, Troy, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/142,434

(22) Filed: Jun. 19, 2008

(51) Int. Cl. F16L 9/14; F16L 9/18; E04F 17/02; F24F 7/00

(52) U.S. Cl. 138/148; 138/112; 454/1; 454/241; 138/141

(57) ABSTRACT

A conduit assembly and a method of manufacturing the same are disclosed and described. The conduit assembly has an outer wall, an inner wall, and a corrugated wall disposed between the outer and inner wall. A conduit section is formed by connecting a plurality of conduit assemblies to enclose a hollow space along the length of the conduit section. The conduit sections may be joined by an axial connector to form a conduit. In one exemplary application, the conduit comprises a fiberglass reinforced plastic material and is used as a stack or chimney liner.

### TECHNICAL FIELD

The present disclosure relates to modular conduit structures, and more particularly to modular conduit structures that are suitable for use in corrosive gaseous environments such as in industrial exhaust systems, including flue gas stacks and chimneys.

### BACKGROUND

Power plants, boilers, and furnaces typically include an exhaust system with a stack or other conduit for releasing gaseous materials such as flue gases. Many known processes release flue gases that include corrosive components, which can damage typical stack materials. To protect the stack, conduit liners are typically used to act as a barrier between the discharged gases and the stack. However, many known stack liners use metals that are scarce and/or expensive. For example, 310 Stainless Steel is often used as a stack liner for flue gases produced in the burning of fossil fuels because it resists scaling up to 1,900° F. Alternatively 316 (& 316L) Stainless Steel includes molybdenum and is sometimes used due to its improved corrosion resistance to most chemicals, salts, and acids as compared to conventional stainless steels. Inconel 600 is also used as a stack liner and is good for extended use at high temperatures and resists corrosion by most simple acids and very pure water. However, owing to its high nickel and chromium content alloy, Inconel 600 is more expensive than most stainless steels. Other known stack liner materials include 321 Stainless Steel and Hastelloy-X.

Known stack liners are typically difficult, expensive, and time-consuming to assemble and install. Such liners are typically manufactured in large conduit sections that must be shipped to the construction sites or, more often, they must be manufactured onsite. Many known liners also require special welding techniques and are heavy. Typically, multiple liner sections are lifted into place by cranes or by helicopters. These large conduit sections typically cannot be nested during shipment and therefore occupy a significant amount of truck bed area, a well as occupying significant ground area at the work site.

In light of the foregoing, a need has arisen for a modular conduit. While the modular conduit described herein are well-suited for stack liner applications, they can also be used in a wide variety of liquid and gaseous fluid movement applications, and the reference to stack liner applications is only exemplary.

### BRIEF DESCRIPTION OF THE DRAWINGS

Embodiments will now be described, by way of example, with reference to the accompanying drawings, wherein:

FIG. 1 is a perspective view of an exemplary conduit constructed from three conduit sections;

FIG. 2A is an exploded view of a cross-section of a portion of an exemplary conduit section taken along line 2-2 in FIG. 1 with the axial connector removed;

FIG. 2B is a cross-sectional view taken through line 2-2 of FIG. 1 illustrating one exemplary conduit section with an attached axial connector;

FIG. 3A is cross-sectional view taken through line 3-3 of FIG. 2 illustrating certain details of the exemplary conduit section and axial connector;

FIG. 3B is a perspective view of a portion of an axial connector with a mounting tab for mounting a conduit to another structure;

FIG. 4 is a partly cutaway enlarged view of a conduit section of the exemplary conduit structure of FIG. 1 showing a conduit assembly with the outer wall and sidewalls removed.

FIG. 5 is an enlarged view of region 5 of FIG. 2B illustrating further details of the conduit assemblies of an exemplary conduit section;

FIG. 6 is a view similar to FIG. 5 but illustrating an alternative exemplary structure; and

FIG. 7 is a partial cutaway top plan view of a bell and spicket joint used to connect adjacent conduit assemblies.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

The present disclosure provides a modular conduit structure and a method of manufacturing the sectional structure that facilitate shipping components to a worksite in modular form and then assembling them at the worksite. As will be described in greater detail below, the sectional structure may be used to form conduits, such as for chimney liners, and for other structures.

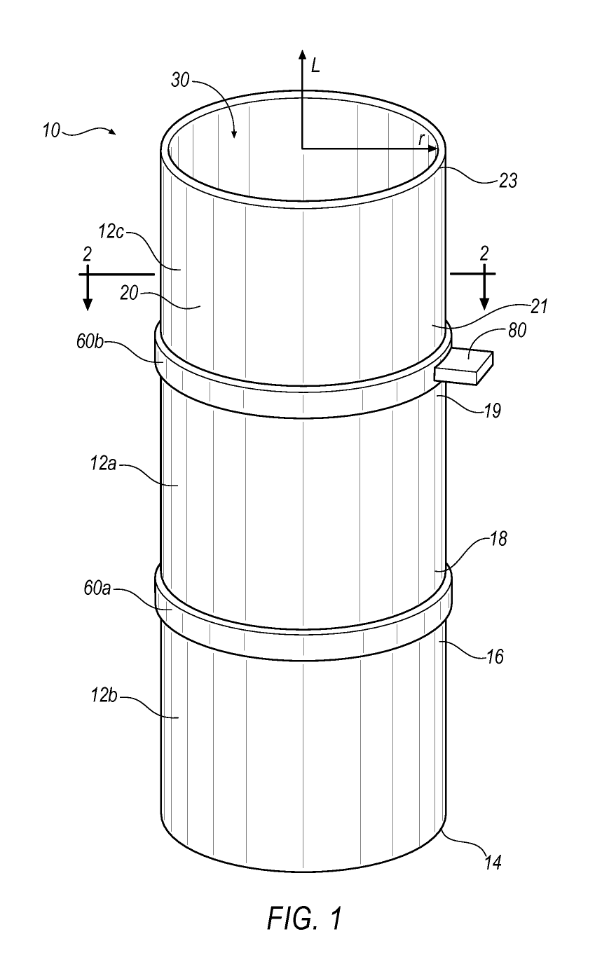

FIG. 1 illustrates an exemplary conduit 10. Conduit 10 may be used for the conveyance of fluids (i.e., liquids and/or gases). In one exemplary embodiment, conduit 10 is used as a stack liner in a chimney or exhaust stack. In certain preferred embodiments, conduit 10 is used to convey corrosive fluids.

Conduit 10 is constructed from a plurality of modular conduit sections, 12a, 12b, and 12c. Any number of conduit sections 12a, 12b, and 12c can be used to create a conduit of the desired length. The various conduit sections each have a length in the axial direction “L” and enclose a hollow space within the length through which liquids or gases may pass. Each conduit section has first and second axial ends 14, 16, 18, 19, 21 and 23. The upper end 16 of the conduit section 12b is connected to lower end 18 of conduit section 12a, and upper end 19 of conduit section 12a is connected to lower end 21 of conduit section 12c. Axial connectors 60a and 60b connect the conduit section 12b to the conduit section 12a and connect the conduit section 12a to the conduit section 12c, respectively, as will be described below. Axial connector 60b includes a mounting tab 80 which allows the conduit 10 to be connected to another structure, such as a flue gas or exhaust stack, not shown. Conduit sections 12a-12c may be provided in any desired lengths. However, the length is preferably selected to provide ease of transport and installation. Exemplary lengths of conduit sections 12a-12c are generally from about 2 feet to about 50 feet. In one exemplary conduit section, a length of 25 feet is provided.

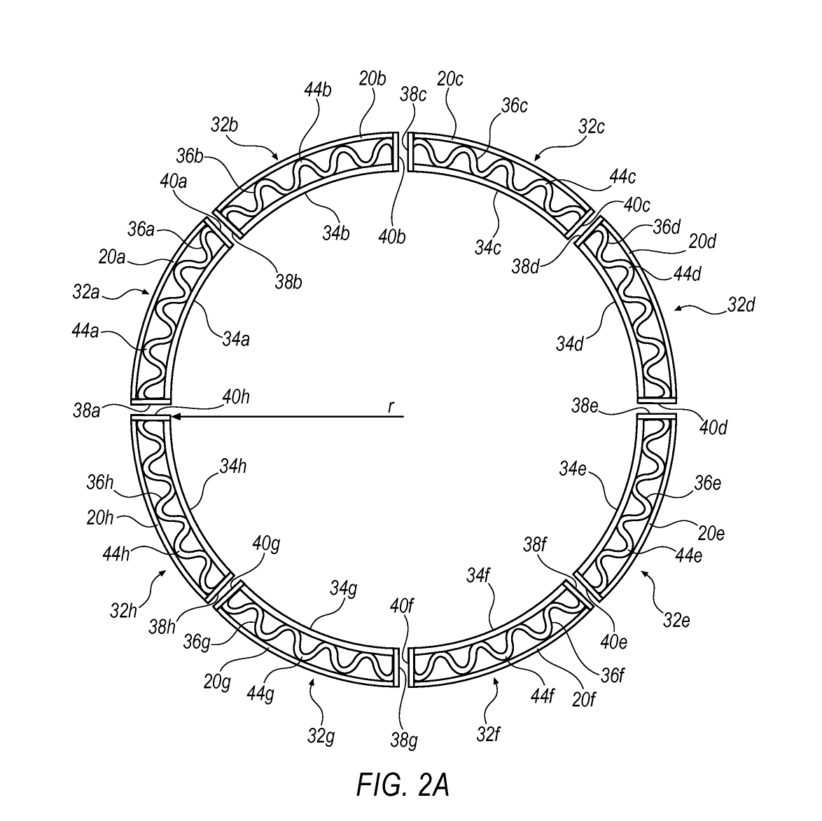

As shown in FIGS. 2A and 2B, the conduit sections 12a, 12b and 12c each comprise a plurality of conduit assemblies 32a-32h which are circumferentially adjacent one another and which are attached to one another to define a continuous conduit structure having an axial length and enclosing a hollow interior along the length. The conduit assemblies 32a-32h may have a variety of different geometric shapes. However, in the embodiment of FIG. 2A, conduit assemblies 32a-32h are generally arcuate and can be connected to one another to define a cylindrical conduit section having open axial ends, such as conduit sections 12a, 12b, and 12c in FIG. 1.

A variety of materials may be used to construct the conduit sections 12a, 12b, and 12c. In one configuration, each conduit section comprises a plastic material. The plastic preferably comprises a resin that is structurally reinforced. In one especially preferred embodiment, the resin is structurally reinforced with fiberglass to provide fiberglass reinforced plastic or “FRP”. The plastic material is selected to withstand the mechanical, thermal, and chemical environment to which the conduit sections 12a-12c will be exposed. In one exemplary application, the conduit sections 12a-12c are used to form a liner for a flue gas or exhaust stack. For this application, certain preferred resins include isophthalic polyester and vinyl esters such as epoxy vinyl esters.

Where fiberglass structural reinforcement is provided, fiberglass amounts may range generally from about 20% to about 60% by weight of plastic. In certain exemplary configurations, the amount of fiberglass ranges from about 35% to about 55% by weight, with amounts ranging from about 45% to about 50% by weight of the plastic being especially beneficial. The fiberglass may be provided in a variety of alignments, including continuous, straight, bi-directional; woven; and chopped strand. However, for applications in which increased structural properties and dimensional stability are required, a continuous, straight, bi-directional alignment is most appropriate. Suitable fiberglass-reinforced isophthalic polyesters include the TuffSpan® isophthalic polyesters supplied by Enduro Composites of Fort Worth Tex. Suitable fiberglass-reinforced vinyl esters include the TuffSpan® vinyl esters and the Derakane® epoxy vinyl ester resins supplied by Dow Chemical of Midland, Mich. The TuffSpan® fiberglass reinforced isophthalic polyesters and vinyl esters have an ultimate tensile strength (longitudinal) of about 42,000 psi as measured by the ASTM D638 test and an ultimate compressive strength (longitudinal) of about 37,000 psi as measured by the ASTM D695 test. The TuffSpan® fiberglass reinforced isophthalic polyesters have an ultimate tensile strength (transverse) of about 7,000 psi and an ultimate compressive strength (transverse) of about 15,000 psi. The corresponding transverse tensile and compressive strengths for TuffSPan® fiberglass reinforced vinyl esters are somewhat higher, 10,000 psi (tensile) and 20,000 (compressive).

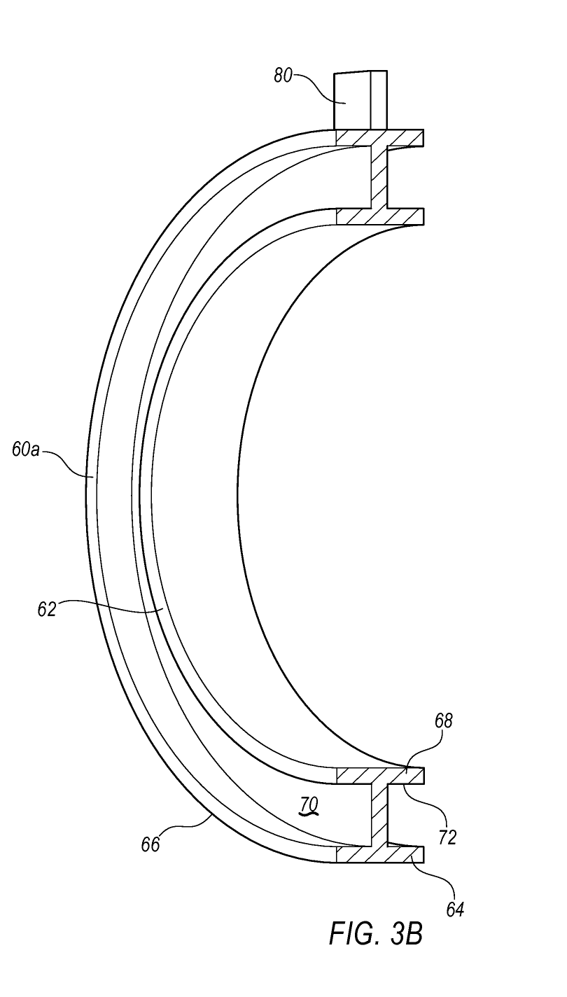

Referring again to FIG. 2A, each conduit assembly 32a-32h includes an outer wall 20a-20h, a corresponding inner wall 34a-34h, and a corresponding corrugated wall 36a-36h. Each corrugated wall has a plurality of apexes 44a-44h and is disposed in the space defined between the corresponding inner wall 34a-34h and outer wall 20a-20h. As best seen in FIGS. 2A and 5, in certain exemplary configurations, each conduit assembly 32a-32h further comprises a pair of corresponding side walls (e.g., side walls 38a and 40a for assembly 32a, sidewalls 38b and 40b for assembly 32b, etc.) which are connected to the corresponding inner wall 34a-34h and outer wall 20a-20h. In accordance with this configuration, each inner wall, outer wall, and corresponding pair of sidewalls defines an enclosure in which the corresponding corrugated wall is disposed. Thus, for conduit assembly 32a, outer wall 20a, inner wall 34a, and side walls 38a and 40a define an enclosure in which corrugated wall 36a is disposed. The same holds true for the other conduit sections 32b-32h as shown in FIG. 2A.

In the embodiment of FIG. 2A, the apexes 44a-44h define adjacent apex pairs (see apex pair 44a1 and 44a2 and apex pair 44b1 and 44b2 in FIG. 5), such that immediately adjacent apexes are spaced apart from one circumferentially and transversely (i.e., in a direction that is transverse to the length of the conduit section, which in the embodiment of FIGS. 2A and 2B is in the radial direction “r”). In one embodiment, each adjacent pair of apexes from among apexes 44a-44h includes one apex proximate its corresponding inner wall 34a-34h and another apex proximate its corresponding outer wall 20a-20h. Thus, in FIG. 5 apex 44a1 is proximate outer wall 20a while apex 44a2 is adjacent inner wall 34a. In certain illustrative configurations, the corrugated shape of walls 36a-36h allows for transverse (or radial in the case of circular conduit sections) expansion and compression of conduit sections 12a-12c, which allows the conduit sections to transversely adjust in thickness to account for thermal and mechanical stresses. Thus, the corrugations provide for longitudinal structural strength and enhanced hoop stress values. In one embodiment wherein the corrugations are generally circular, their radius of curvature ranges from about 0.5 in. to about 5 in., with radii of curvature of from about 1 in. to about 3 in. being preferred and a radius of curvature of about 1.5 in. being especially preferred.

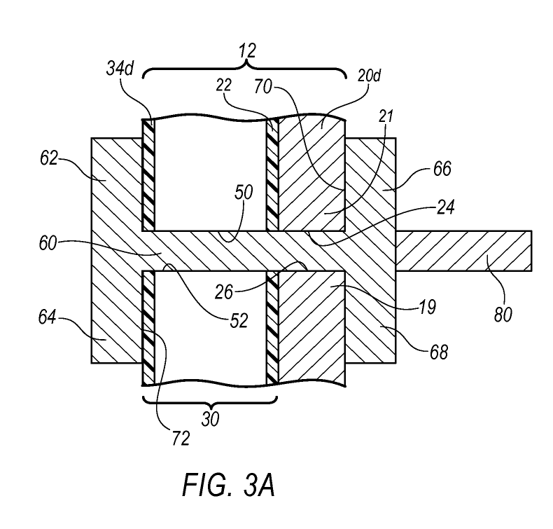

As best seen in FIG. 4, apexes 44a-44h of corrugated walls 36a-36h have a length (“L apex”) that is substantially co-extensive with the length of their respective conduit section (e.g., conduit sections 12a-12c). In certain exemplary applications, conduit assemblies 32a-32h have a generally arcuate cross-section when viewed from a top or bottom plan view. However, other shapes are possible. For example, planar conduit assemblies may be used to define a duct with a square or rectangular cross-sectional profile.

The conduit assemblies 32a-32h define adjacent pairs of conduit assemblies (32a/32b, 32b/32c, 32c/32d, 32e/32f, 32f/32g, 32g/32h, and 32h/32a) which are preferably connected to each other along their axial lengths (i.e., the direction L in FIG. 1) to define a circumferentially completed conduit section, e.g. 12a, 12b, or 12c. As mentioned previously, in one exemplary configuration, each conduit assembly 32a-32h includes opposite side walls 38a-38h and 40a-40h such that each conduit assembly 32a-32h has a sidewall in facing opposition to a sidewall of an adjacent conduit assembly 32a-32h. As shown in FIG. 2A, sidewall 38a of the conduit assembly 32a, is spaced apart from sidewall 40a at the opposite circumferential end of conduit assembly 32a and may be similarly positioned adjacent the sidewall 40h of another conduit assembly 32h. Similarly, sidewall 40b of conduit assembly 32b is spaced apart from sidewall 38b at the opposite circumferential end of conduit assembly 32b and may be similarly positioned adjacent the sidewall 38c of another conduit assembly 32c. The other conduit assemblies 32c-32h are similarly configured.

FIG. 5 depicts a partial, transverse cross-section of adjacent conduit assemblies 32a and 32b of a conduit section such as conduit sections 12a-12c. As the figure indicates, sidewall 40a is connected to outer wall 20a and inner wall 34a, while sidewall 38b is connected to outer wall 20b and inner wall 34b. Sidewalls 38b and 40a are disposed in facing opposition to one another and in certain embodiments abuttingly engage one another. The same holds for the sidewalls of the remaining pairs of adjacent conduit assemblies. The sidewalls 38b and 40a may be connected using a suitable technique that will withstand the mechanical, thermal, and chemical environment to which the conduit 10 will be exposed. In one embodiment, sidewalls 38b and 40a are connected along their lengths by adhesive 42 using a butt and glue joint. In one arrangement that is suitable for use in corrosive flue gas environments, adhesive 42 comprises a methacrylate adhesive that cures at room temperature and has a cured tensile strength of from about 2000 to about 4000 psi. One such adhesive is Speedbonder® H8000, which is supplied by the Loctite Company of Rocky Hill, Conn. In addition to connecting adjacent conduit assemblies 32a and 32b, adhesive 42 preferably creates a barrier that reduces or eliminates the radial egress of corrosive gas components that could damage the stack. An optional barrier layer, such as a fiberglass hand lay up strap joint 48, may also be applied along the axial length of the seam defined between side walls 38b and 40a to reduce gas losses through the seam. Suitable fiberglass hand lay up strap joints include those made from vinyl ester, polyester, and/or epoxy resins. The fiberglass hand lay up strap joint 48 not only acts as a barrier layer, but also increases the structural integrity of the conduit section formed from conduit assemblies 32a and 32b.

Referring to FIGS. 2A and 5, corrugated walls 36a-36h may be connected to their respective inner walls 34a-34h by a variety of methods. However, in one illustrative method, a corrosion-resistant adhesive such the methacrylate adhesive described above is used. The adhesive may be applied in a variety of ways, including by applying the adhesive to those apexes from among apexes 44a-44h that face inner walls 34a-34h. Similarly, those apexes from among apexes 44a-44h that face the outer walls 20a-20h may be adhesively bonded to their corresponding outer wall inner surfaces 22a-22h (22a and 22b are shown in FIG. 5). In those configurations wherein rounded corrugations are used, the apexes 44a-44h may optionally be provided with a substantially flattened region to provide increased surface area contact for improved adhesion to the inner walls 34a-34h and the outer walls 20a-20h. In one preferred method of application, adhesive is applied to axial ends of the apexes 44a-44h to connect the apexes to the inner walls 34a-34h and outer walls 20a-20h.

As shown in FIG. 5, each pair of circumferentially adjacent apexes (e.g., apexes 44a1 and 44a3 in FIG. 5) defines a corresponding space 54a which is substantially co-extensive with the length of the corresponding conduit section (e.g., 12a-12c). These spaces 54a may optionally be used to accommodate filler materials that serve a variety of purposes. For example, space 54a may be filled with structural foam to impart additional structural rigidity and/or vibrational damping to the conduit section 12a-12c. It may also be filled with an insulative material having a selected r-value to reduce thermal losses. The filler may be added to spaces 54a by a variety of methods. However, in one illustrative method, it is accomplished by placing long tubes down the spaces 54a and filling spaces 54a while pulling tubes out of the spaces.

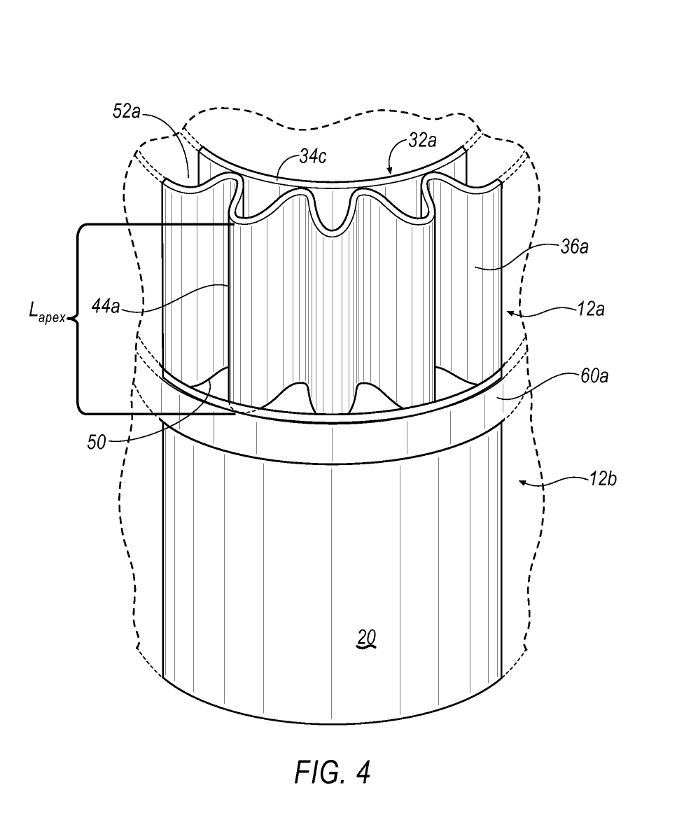

FIG. 6 depicts an alternate configuration of two adjacent conduit assemblies 32a and 32b of a conduit section such as conduit sections 12a-12c. In the configuration of FIG. 6, corrugated walls 36a and 36b are generally in the form of a square wave and have substantially flat apexes 44a. The particular shape of the corrugations (e.g., square or rounded) is preferably selected based on the pressure (positive pressure or vacuum pressure) and/or specific gravity of the fluid (gas or liquid) being conveyed through conduit sections 12a-12c. Other than the shape of the corrugations, the embodiment of FIG. 6 is configured similarly to the previous embodiments.

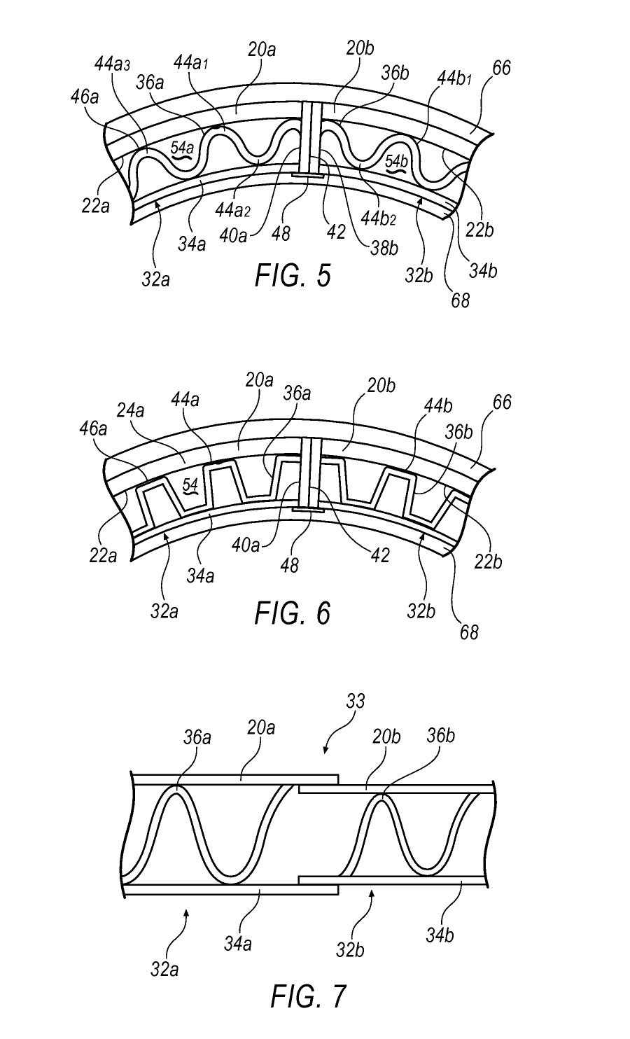

In the embodiment of FIGS. 2A-5, adjacent conduit assemblies (e.g., assemblies 32a and 32b) are joined together by connecting adjacent sidewalls such as sidewall 40a of assembly 32a and sidewall 38b of assembly 32b. However, in certain exemplary embodiments adjacent conduit assemblies are connected without the use of sidewalls. One such embodiment is depicted in FIG. 7. As shown in FIG. 7, one end of conduit assembly 32a is flared relative to the adjacent conduit section 32b. As a result, a “bell and spicket” joint 33 is formed by inserting the relatively narrower assembly 32b into the relatively wider assembly 32a. If desired, the overlapping portions of outer walls 20a and 20b may be connected by an adhesive, including without limitation the methacrylate adhesive described previously. The overlapping portions of inner walls 34a and 34b may be attached similarly.

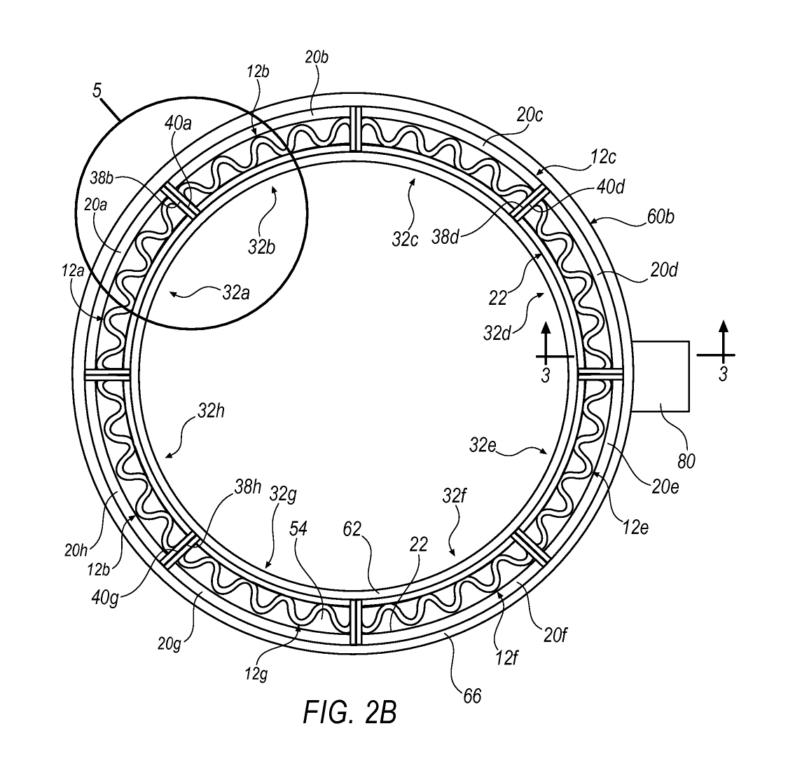

Referring again to FIG. 1, to form a completed conduit, one or more conduit sections 12a- 12c are connected. In one embodiment wherein the conduit is generally straight, the conduit sections 12a-12c are aligned axially and connected by axial connectors 60a and 60b. Connectors 60a and 60b may be constructed from a variety of materials, including fiberglass, stainless steel, or alloy. Suitable alloys include Hastelloy and titanium. However, if an alloy is used, Hastelloy (a Ni—Cr alloy) is preferred. As FIG. 1 indicates, the axial connector 60b connects the upper end 19 of the conduit section 12a to the lower end 21 of conduit section 12c and the axial connector 60a connects the upper end 16 of the conduit section 12b to the lower end 18 of conduit section 12a. The axial connector 60b is shown as viewed in an assembled state from above in FIG. 2B, which illustrates a cross-section through the conduit section 12c. Connector 60b is shown in an unassembled perspective cutaway view in FIG. 3B. Connector 60b can also be seen in an assembled state in the views of FIGS. 3A, 5, and 6. Axial connector 60b includes a mounting connector 80 for connecting conduit 10 to a corresponding recess (not shown) defined in a secondary structure such as stack or chimney (not shown) in which conduit 10 is inserted. In the embodiment of FIG. 1, the mounting connector 80 is a generally square tab. However, other tab geometries (e.g., block or cylindrical) may also be used. As FIG. 1 suggests, each axial connector need not include a mounting connector. Instead, mounting connectors may be placed at suitable intervals to provide the required degree of retention to the secondary structure of interest.

In the embodiment of FIG. 1, the first and second axial ends of each conduit section are open. The open ends allow for the movement of fluids through conduit sections 12a-12c. Depending on the application, one or more of conduit sections 12a- 12c may require a manway or an inlet at a location along their lengths to admit personnel or fluids. In one exemplary embodiment, at least one of conduit sections 12a-12c includes a standard flanged inlet duct and piped as provided by the fiberglass industry and described in ASTM D3299, which is hereby incorporated by reference in its entirety.

For certain long span stacks that may be subjected to significant moments, an expansion device and connector may be provided at specific locations along the conduit 10. In one embodiment, the expansion device and connector comprises a flange-by-flange gasketed bellows disposed between axially adjacent conduit sections. In accordance with the embodiment, the flanges will preferably be made of steel, and the bellows will preferably be made from EPDM or a fluoroelastomer such as Viton®, a product of DuPont Performance Elastomers.

As shown in FIGS. 3A and 3B, in one illustrative depiction, the axial connector 60b is an annular ring having upper and lower channels 70 and 72, respectively. The upper channel 70 is defined between two upwardly-extending flanges 62 and 66. The flange 66 is positioned radially outward of flange 62 and channel 70. Correspondingly, the lower channel 72 is defined between two downwardly-extending flanges 64 and 68. The flange 68 is positioned radially outward of flange 64 and lower channel 72. The heights of the flanges 62, 64, 66, and 68 are preferably selected so that axial connector 60b overlaps a sufficient portion of conduit sections 12a and 12c to provide secure retention thereof. In one embodiment, the flange heights range generally from about 1 percent to about 5 percent of the total length of conduits 12a and 12c. In one exemplary embodiment wherein the conduit lengths are about 25 feet, the flange heights are about 2 percent of the total length of conduits (i.e., 6 inches).

As shown in FIG. 3A, the lower end 21 of the upper conduit section 12c is inserted into the channel 70 of the axial connector 60b such that the inner wall 34d of the conduit assembly 32d is placed in facing opposition to the inner flange 62. The outer wall 20d is placed in facing opposition to the outer flange 66. Although not separately depicted, the inner wall and the outer wall of the lower conduit section 12c are similarly oriented with respect to downwardly extending flanges 64 and 68. The conduit sections 12a and 12c and channels 70 and 72 are preferably sized to allow for insertion of the conduit sections into axial connector 60b while providing a generally snug fit. An adhesive of the type described previously may be applied to the surfaces of the axial connector and/or the conduit sections to facilitate secure retention. As the foregoing suggests, the axial connectors 60a and 60b allow the conduit sections 12a-12c to be shipped in their unassembled site and then assembled on-site to create the conduit 10. While the embodiment of FIGS. 3A and 3B depicts a circular ring, other axial connector geometries may be used (e.g., square, rectangular, etc.) depending on the shape of conduit 10.

The axial connectors 60a and 60b may be constructed from a variety of materials. However, in corrosive environments such as flue gas stacks, fiberglass reinforced plastics, stainless steel, or Hastalloy are most suitable.

While the foregoing examples have included circular conduit cross-sections, it will be appreciated that non-circular cross-sections can be used, such as square or rectangular cross-sections, where appropriate. Furthermore, while the drawings and description above provide for the use of a plurality of identically shaped sectional structures being joined together, it will be appreciated that, where appropriate, many alternative shapes of sectional structures or alternative structures are possible for use together with sectional structures to form a conduit, such as transition pieces, elbows, diverters, dividers junctions, filters, heaters, coolers, dehumidifiers, humidifiers, injectors, pumps, sensors, and valves, depending on the content and purpose of the conduit. Different conduit sections can be connected to define angled conduits and conduits of differing internal radii or surface area. Conduits such as the conduit 10 may be used as stand-alone structures for the conveyance of fluids, or they may be inserted into secondary structures such as chimneys or stacks (e.g., via the attachment of mounting connector 80) and used as stack liners.

Methods of making conduit sections 12a-12c will now be described with reference to FIGS. 1-6. The geometry of the conduit sections and components is merely illustrative, and other geometries may be used. In one exemplary method involving stack liner applications, the conduits sections 12a-12c are fabricated off-site from the location of use. After forming and transferring conduit sections 12a- 12c to the location of use, first conduit section 12b is inserted into the stack (e.g., with a crane or helicopter). The axial connector 60a is then attached to the upper end 16 of the first conduit section 12b. Although a number of attachment methods may be used, in one exemplary method, an adhesive is applied to the lower channel (not separately shown) of the axial connector 60a before it is set in place on conduit section 12b. In another embodiment, the axial connector 60a is applied to the upper end 16 of the conduit section 12b and the combined structure is then inserted into the stack. In a preferred embodiment, the conduit sections 12a-12c are fabricated from a fiberglass reinforced plastic of the type described previously to facilitate transportation and installation.

In accordance with the exemplary method, the conduit section 12a is then connected to the axial connector 60a. In one illustrative method of connection, an adhesive is applied to the lower end 18 of the conduit section 12a (i.e., to all or part of one or more of the lower axial edges of its outer wall, inner wall, and corrugated wall) and/or the upper end 19 of the conduit section 12a. The conduit section 12a is then disposed in the upper channel (not separately shown) of the axial connector 60a. The process is then repeated to connect the conduit section 12c to the conduit section 12a with the axial connector 60b. However, in the case of the axial connector 60b, the mounting tab 80 is preferably aligned with and secured to a complementary recess (not shown) in the stack before connecting conduit section 12c. Alternatively, conduit sections 12a-12c may be connected to one another to form conduit 10, and conduit 10 may then be inserted into the stack. Conduit 10 may also be completed and used for other fluid conveyance or handling operations aside from stack liner applications.

An exemplary method of manufacturing conduit assemblies 32a-32h will now be described. In accordance with the method, a die is provided which provides the desired profile of corrugated walls 36a-36h. The die is preferably shaped to provide the number and desired degree of curvature for each individual corrugation, as well as to provide the desired overall radius of curvature of each corrugated wall 36a-36h. Each corrugated wall 36a-36h is then formed by forcing a mixture of resin and glass fibers through the die, either using a pushtrusion or a pultrusion process. However, a pultrusion process is preferred. Each corrugated wall 36a-36h is cut to the desired length after they exit the die and allowed to cure.

Inner walls 34a-34h and outer walls 20a-20h are preferably formed by providing an inner wall mold and an outer wall mold (not shown), each having a cavity that is shaped to form the respective wall with the desired radius of curvature. The walls are then formed by applying resin and glass fibers to the mold via a hand lay up process and allowing the resin to cure at a selected temperature for a selected time. In certain embodiments, the resins of the type described previously are used and the curing is carried out at room temperature for a period of from about 8 to about 12 hours. A suitable catalyst may be combined with the resin to facilitate curing.

Once inner walls 34a-34h and outer walls 20a-20h are formed they are connected to corrugated walls 36a-36h. In one exemplary method, an adhesive is applied on apexes 44a-44h at locations that are spaced apart along the length of the apexes 44a-44h. The inner walls 34a-34h are then press bonded to their corresponding corrugated walls 36a-36h as are the corresponding outer walls 20a-20h. In accordance with the exemplary method, side walls 38a-38h and 40a-40h comprise fiberglass reinforced plastics of the type described previously. The side walls 38a-38h and 40a-40h are applied to their corresponding inner walls 34a-34h and outer walls 20a-20h via a hand layup process to define an enclosure within which the corresponding corrugated wall 36a-36h is disposed. In one exemplary embodiment, an adhesive of the type described previously (e.g., a methacrylate adhesive) is then applied to side walls 38a-38h and/or 40a-40h. Adjacent sidewalls (e.g., side walls 40a and 38b) are then press bonded together to connect adjacent conduit assemblies (e.g., assemblies 32a and 32b). The process is continued until a conduit section (e.g., sections 12a-12c) is completed. The conduit sections may then be connected axially to define a conduit as described above.

In accordance with another exemplary method, inner walls 34a-34h and outer walls 20a-20h are molded as generally planar structures which are subsequently bent and attached to the corresponding corrugated walls 36a-36h. However, depending on the thickness and materials of construction used to form conduit assemblies 32a-32h, the inner walls 34a-34h and outer walls 20a-20h may have to be molded with the final radius of curvature in order to attach them to their corresponding corrugated walls 36a-36h.

It will be appreciated that the conduit sectional structures described herein have broad applications for liquid and gas handling and conveyance, including for smoke stacks, smoke stack liners, ducts or duct liners for general purposes, scrubber outer shells, liquid storage tanks, or as above ground or underground pipe.

The foregoing embodiments were chosen and described in order to illustrate principles of the methods and apparatuses as well as some practical applications. The preceding description enables others skilled in the art to utilize methods and apparatuses in various embodiments and with various modifications as are suited to the particular use contemplated. It is intended that the scope of the present methods and apparatuses be defined by the following claims. In accordance with the provisions of the patent statutes, the principles and modes of operation of this invention have been explained and illustrated in exemplary embodiments. However, it must be understood that this invention may be practiced otherwise than is specifically explained and illustrated without departing from its spirit or scope.

What is claimed as new and desired to be protected by Letters Patent of the United States is:

1. A conduit assembly, comprising:
an outer wall;
an inner wall; and
a corrugated wall, wherein the corrugated wall comprises a plurality of apexes and the corrugated wall is disposed between the outer wall and the inner wall.

2. The conduit assembly of claim 1, wherein the conduit assembly has an axial direction and a transverse direction, and adjacent apexes in the plurality of apexes are spaced apart from one another in the transverse direction.

3. The conduit assembly of claim 1, wherein the conduit assembly has a length in the axial direction and each apex in the plurality of apexes extends along the length of the conduit assembly.

4. The conduit assembly of claim 1, wherein each apex in the plurality of apexes abuts one of the outer wall and the inner wall.

5. The conduit assembly of claim 1, wherein each apex in the plurality of apexes is connected to one of the outer wall and the inner wall.

6. The conduit assembly of claim 1, wherein the inner wall and the outer wall define a space between the inner wall and outer wall, and the corrugated wall is substantially disposed within the space.

7. The conduit assembly of claim 1, further comprising two side walls, wherein each of the side walls is connected to at least one of the inner wall and the outer wall.

8. The conduit assembly of claim 7, wherein each of the side walls is connected to the inner wall and the outer wall.

9. The conduit assembly of claim 1, wherein the outer wall is a first outer wall, the inner wall is a first inner wall, the corrugated wall is a first corrugated wall, the first outer wall, the first inner wall, and the first corrugated wall define a first conduit section having a length, the conduit assembly further comprises a second conduit section having a length, a second outer wall, a second inner wall, and a second corrugated wall disposed between the second outer wall and the second inner wall, and the first conduit section is connected to the second conduit section along at least a portion of the length of the first conduit section and at least a portion of the length of the second conduit section.

10. The conduit assembly of claim 9, wherein the first conduit section has at least one side wall, the second conduit section has at least one side wall, and the at least one side wall of the first conduit section is connected to the at least one side wall of the second conduit section, thereby defining a seam between the connected sidewalls.

11. The conduit assembly of claim 10, further comprising a barrier layer disposed over the seam along at least a portion of the length of the seam.

12. The conduit assembly of claim 1, wherein the outer wall and the inner wall define a plurality of spaces between the outer wall and the inner wall, and the conduit assembly further comprises a filler material disposed in the plurality of spaces.

13. The conduit assembly of claim 1, wherein the outer wall and the inner wall are substantially arcuate.

14. The conduit assembly of claim 1, wherein the outer wall, the inner wall, and the corrugated wall are formed from plastic.

15. The conduit assembly of claim 14, wherein the plastic comprises a resin reinforced with fiberglass.

16. The conduit assembly of claim 15, wherein the resin comprises one selected from isophthalic polyester, vinyl ester, and combinations thereof.

17. The conduit assembly of claim 16, wherein the resin comprises an epoxy vinyl ester resin.

18. The conduit assembly of claim 15, wherein the amount of fiberglass is from about 20 percent to about 60 percent by weight of the total amount of plastic.

19. A conduit section, comprising a plurality of the conduit assemblies of claim 1, wherein the conduit section has an axial length, and the conduit assemblies are connected to one another to enclose a hollow space along the axial length.

20. A fluid transportation system comprising the conduit section of claim 19 and a fluid flowing through the hollow space.

21. An exhaust system, comprising an exhaust stack having the conduit assembly of claim 1 disposed therein.

22. A method of transporting a fluid, comprising:
providing the conduit section of claim 19, wherein the conduit section has an open first end and an open second end spaced apart from the open first end; and
introducing a fluid into the open first end, wherein the fluid flows through the hollow space and exits the open second end.

23. A conduit assembly, comprising:
an outer wall;
an inner wall; and
a corrugated wall, wherein the corrugated wall is disposed between the outer wall and the inner wall, and the outer wall, inner wall, and corrugated wall comprise at least one plastic resin.

24. The conduit assembly of claim 23, wherein the at least one plastic comprises a resin reinforced with fiberglass.

25. The conduit assembly of claim 24, wherein the amount of fiberglass is from about 20 percent to about 60 percent by weight of the total amount of plastic.

26. The conduit assembly of claim 23, wherein the resin comprises one selected from isophthalic polyester, vinyl ester, and combinations thereof.

27. The conduit assembly of claim 26, wherein the resin comprises an epoxy vinyl ester resin.

28. The conduit assembly of claim 23, wherein the corrugated wall comprises a plurality of apexes.

29. The conduit assembly of claim 28, wherein adjacent pairs of apexes in the plurality of apexes are spaced apart from one another in a radial direction.

30. The conduit assembly of claim 28, wherein the conduit assembly has a length and each apex extends along the length of the conduit assembly.

31. The conduit assembly of claim 28, wherein each apex in the plurality of apexes abuts one of the outer wall and the inner wall.

32. The conduit assembly of claim 28, wherein each apex in the plurality of apexes is connected to one of the outer wall and the inner wall.

33. The conduit assembly of claim 23, wherein the inner wall and the outer wall define a space between the inner wall and outer wall, and the corrugated wall is substantially disposed within the space.

34. The conduit assembly of claim 23, wherein the outer wall comprises a first outer wall, the inner wall comprises a first inner wall, the corrugated wall comprises a first corrugated wall, the first outer wall, the first inner wall, and the first corrugated wall define a first conduit section having a length, the conduit assembly further comprises a second conduit section having a length, a second outer wall, a second inner wall, and a second corrugated wall disposed between the second outer wall and the second inner wall, and the first section is connected to the second section along at least a portion of the length of the first section and at least a portion of the length of the second section.

35. The conduit assembly of claim 34, wherein the first conduit section has at least one side wall, the second conduit section has at least one side wall, and the at least one side wall of the first conduit section is connected to the at least one side wall of the second conduit section, thereby defining a seam between the connected sidewalls.

36. The conduit assembly of claim 35, further comprising a barrier layer disposed over the seam along at least a portion of the length of the seam.

37. The conduit assembly of claim 23, wherein the outer wall and the inner wall define a plurality of spaces between the corrugated wall and the inner wall, and the conduit assembly further comprises a filler material disposed in the plurality of spaces.

38. The conduit assembly of claim 23, wherein the corrugated wall comprises generally rounded corrugations.

39. The conduit assembly of claim 23, wherein the corrugated wall comprises generally square corrugations.

40. The conduit assembly of claim 23, wherein the corrugated wall further comprises substantially flat apexes.

41. A conduit section comprising a plurality of the conduit assemblies of claim 20, wherein the conduit section has an axial length, and the conduit assemblies are connected to one another to enclose a hollow space along the length.

42. A fluid transportation system, comprising the conduit section of claim 41 and a fluid moving through the hollow space.

43. An exhaust system comprising an exhaust stack having the conduit assembly of claim 23 disposed therein.

44. A method of transporting fluid, comprising:
providing the conduit section of claim 23, wherein the conduit section has an open first end and an open second end spaced apart from the open first end; and
introducing a fluid into the open first end, wherein the fluid flows through the hollow space and exits the open second end.

45. A method of manufacturing a conduit, comprising:
providing first and second plastic conduit sections, the steps of providing each said conduit section comprising:
providing a plurality of conduit assemblies, each conduit assembly having an outer wall, an inner wall, and a corrugated wall disposed between the outer wall and the inner wall;
connecting the conduit assemblies to define a hollow interior having an enclosed length; and
connecting the first conduit section to the second conduit section.

46. The method of claim 45, wherein the first and second conduit sections each have upper and lower ends, and the step of connecting the first conduit section to the second conduit section comprises providing an axial connector and disposing the lower end of the first conduit section and the upper end of the second conduit section in the axial connector.

47. The method of claim 45, wherein the plastic comprises a resin reinforced with fiberglass.

48. The conduit assembly of claim 47, wherein the amount of fiberglass is from about 20 percent to about 60 percent by weight of the total amount of plastic.

49. The conduit assembly of claim 47, wherein the resin comprises one selected from isophthalic polyester, vinyl ester, and combinations thereof.

50. The conduit assembly of claim 49, wherein the resin comprises an epoxy vinyl ester.
